(19) United States
(12) Patent Application Publication
(10) Pub. No.: US 2024/0028365 A1
(43) Pub. Date: Jan. 25, 2024

(54) HITLESS VIRTUAL MACHINE MIGRATION WITH MIDDLEBOX SERVICE RULES APPLIED

(71) Applicant: VMware, Inc., Palo Alto, CA (US)

(72) Inventors: Han Li, San Jose, CA (US); Li Sun, Sunnyvale, CA (US); Jianjun Shen, Redwood City, CA (US)

(21) Appl. No.: 17/871,934

(22) Filed: Jul. 23, 2022

(51) Int. Cl. G06F 9/455; G06F 9/50

(52) U.S. Cl. CPC G06F 9/45558; G06F 9/5088; G06F 2009/4557; G06F 2009/45587

(57) ABSTRACT

Some embodiments provide a novel method for processing control plane messages regarding migration of a particular machine from a first host computer managed by a first central control plane (CCP) server to a second host computer. At the first CCP server, the method receives a first data message from the first host computer notifying that the particular machine has been removed from the first host computer. The method determines whether a second data message from a second host computer notifying that the particular machine has been added to the second host computer has been received and processed in order to process the first data message. When it is determined that the second data message has been received and processed, the method processes the first data message.

### BACKGROUND

vMotion enables live migration of running virtual machines (VMs) from one physical host to another with zero downtime. When vMotion occurs, middlebox service rules associated with security groups of VMs may change and updates to security groups are sent to hosts in the network. These updates need to be aligned with different vMotion stages (i.e., VM removal on one host, VM addition on another host) to ensure VM traffic will not be blocked or skipped unexpectedly during vMotion.

If a VM removal for a particular VM migration is processed without the corresponding VM addition, incorrect updates to security groups may be sent to the hosts, resulting in incorrectly processed traffic. It will not be until the VM addition is processed and new updates to the security groups are sent out that all VM traffic will be processed correctly. While some customers find this acceptable, it is not acceptable to mission-critical computing environments, e.g., multi-tenancy cloud computing services. Current implementations do not provide any way to ensure that VM migration is processed in the correct order such that no VM traffic will be incorrectly processed based on incorrect security group updates.

### BRIEF SUMMARY

Some embodiments provide a novel method for processing control plane messages regarding migration of a machine from a first host computer managed by a first central control plane (CCP) server to a second host computer. The first CCP server is part of the CCP that includes two or more CCP servers. At the first CCP server, the method receives a first data message from the first host computer notifying that a particular machine has been removed from the first host computer. Before processing the first data message, the method determines whether a second data message from a second host computer notifying that the particular machine has been added to the second host computer has been received and processed at the central control plane.

When it is determined that the second data message has been received and processed, the method processes the first data message. On the other hand, when it is determined that the second data message has not been received, the method in some embodiments waits a particular period of time in order to process the first data message after the second data message has been received and processed. When the second data message is received and processed during the particular period of time, the method may then process the first data message. When the second data message is not received during the particular period of time, the method in some embodiments sends an error message to another program or to an administrator notifying a potential problem with the VM migration, or stores such an error message in a log file for later review by another program or an administrator.

The particular period of time in some embodiments is specified by an administrator or a user. The method of some embodiments also includes receiving a third data message from the first host computer before receiving the first data message, notifying the first CCP server of the migration of the particular VM from the first host computer to the second host computer. The received third data message notifies the first CCP server to wait to process the first data message before the second data message is received and processed.

In some embodiments, the first CCP server receives one or more middlebox service rules to be applied at multiple VMs, including the particular VM, executing on multiple host computers including the first and second host computers. The middlebox service rules may be received directly from a user or may be received by a manager. The middlebox service rules may specify different security groups including one or more of the VMs on the host computers. For instance, the first CCP server of some embodiments may receive a middlebox service rule specifying a particular security group. The first CCP server may identify the VMs that belong to this security group and send out a data message to the first host computer specifying the middlebox service rule and the identified VMs of the particular security group associated with the middlebox service rule.

After processing the first data message, the method of some embodiments sends a fourth data message to the first host computer specifying one or more updates to one or more security groups. After the first and second data messages are processed and the migration of the particular VM is complete, the first CCP server determines which security groups are affected by this migration, if any. If one or more security groups no longer include or now include the particular VM, the first CCP server sends the fourth data message to the first host computer to notify the first host computer of the updated security groups such that any middlebox service rules associated with these security groups are applied correctly by the first host computer. In some embodiments, if no security groups are affected by the migration, the first CCP server does not send the fourth data message.

In some embodiments, the first CCP server is part of multiple CCP servers each responsible for a different set of one or more host computers (e.g., responsible for configuring its sets of host computers). In some cases, the second data message is received from the second host computer and processed at the first CCP server because this server is responsible for the first and second host computers. In other cases, the second data message is received from the second host computer and processed at a second CCP server that is responsible for the second host computer.

Each CCP server may use a shared database to store and retrieve (1) the middlebox service rules, (2) VM virtual network interface card (vNIC) to logical switch port mappings for the VMs and a logical switch associated with the host computers, and (3) host computer and VM statuses for each of the host computers and VMs. Each CCP server may retrieve a middlebox service rule from the shared database and identify members of the security groups for the middlebox service rule. A CCP server may also retrieve VM vNIC to logical switch port mappings from other CCP servers via the shared database, and store new/updated mappings in the shared database for other CCP servers.

The host computer and VM statuses specify which VMs are currently operating on which host computers. After the migration of the particular VM, the first CCP server updates the host computer and VM status to remove the association between the particular VM and the first host computer. When the first CCP server receives and processes the second data message from the second host computer, the first CCP server also updates the host computer and VM statuses to add that the particular VM is now executing on the second host computer. When the second CCP server receives and processes the second data message from the second host computer, the second CCP server updates the host computer and VM statuses to add that the particular VM is now executing on the second host computer.

The preceding Summary is intended to serve as a brief introduction to some embodiments of the invention. It is not meant to be an introduction or overview of all inventive subject matter disclosed in this document. The Detailed Description that follows and the Drawings, that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates an example architecture of a network in which some embodiments of the invention are implemented.

FIG. 2 illustrates an example network including hosts that send data messages to notify a CCP of a VM migration.

FIG. 3 conceptually illustrates a process of some embodiments to process a VM migration from a first host to a second host.

FIG. 4 illustrates an example architecture of CCP nodes of one CCP and a shared database used by all CCP nodes of the CCP.

FIG. 5 illustrates an example CCP node of a CCP and a shared database.

FIG. 6 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for processing control plane messages regarding migration of a machine from a first host computer managed by a first central control plane (CCP) server to a second host computer. The first CCP server is part of the CCP that includes two or more CCP servers. At the first CCP server, the method receives a first data message from the first host computer notifying that a particular machine has been removed from the first host computer. Before processing the first data message, the method determines whether a second data message from a second host computer notifying that the particular machine has been added to the second host computer has been received and processed at the central control plane.

When it is determined that the second data message has been received and processed, the method processes the first data message. On the other hand, when it is determined that the second data message has not been received, the method in some embodiments waits a particular period of time in order to process the first data message after the second data message has been received and processed. When the second data message is received and processed during the particular period of time, the method may then process the first data message. When the second data message is not received during the particular period of time, the method in some embodiments sends an error message to another program or to an administrator notifying a potential problem with the VM migration, or stores such an error message in a log file for later review by another program or an administrator.

The particular period of time in some embodiments is specified by an administrator or a user. The method of some embodiments also includes receiving a third data message from the first host computer before receiving the first data message, notifying the first CCP server of the migration of the particular VM from the first host computer to the second host computer. The received third data message notifies the first CCP server to wait to process the first data message before the second data message is received and processed.

In some embodiments, the first CCP server receives one or more middlebox service rules to be applied at multiple VMs, including the particular VM, executing on multiple host computers including the first and second host computers. The middlebox service rules may be received directly from a user or may be received by a manager. In some embodiments, the middlebox service rules specify different security groups including one or more of the VMs on the host computers.

For instance, the first CCP server of some embodiments receives a middlebox service rule specifying a particular security group. The first CCP server may identify the VMs that belong to this security group and send out a data message to the first host computer specifying the middlebox service rule and the identified VMs of the particular security group associated with the middlebox service rule. When VM migration occurs, the first CCP server updates affected security groups and sends out a notification to the first host computer notifying of any updates to security groups caused by the VM migration. In order to provide the first host computer with correct updates to security groups, the first CCP server must wait to process the first data message until the second data message is received and processed. In some embodiments, the second data message is received and processed at the first CCP server. In other embodiments, the second data message is received and processed at a second CCP server. If the first CCP server were to process a VM removal data message without its corresponding VM addition data message being received and processed, the first CCP server may provide incorrect updates to security groups to the first host computer, resulting in middlebox service rules that are incorrectly applied at the first host computer. In order to avoid this issue, the first host computer sends the first CCP server a third data message notifying of the VM migration before sending the first data message notifying of the VM removal. Receiving the third data message notifies the first CCP server to wait to process the first data message before the second data message is received and processed.

After processing the first data message, the method of some embodiments sends a fourth data message to the first host computer specifying one or more updates to one or more security groups. After the first and second data messages are processed and the migration of the particular VM is complete, the first CCP server determines which security groups are affected by this migration, if any. If one or more security groups no longer include or now include the particular VM, the first CCP server sends the fourth data message to the first host computer to notify the first host computer of the updated security groups such that any middlebox service rules associated with these security groups are applied correctly by the hosts. In embodiments where the first CCP server receives and processes the second data message, the first CCP server also sends the fourth data message to the second host computer to notify the second host computer of the updated security groups. In embodiments where the second CCP server receives and processes the second data message, the second CCP server sends the fourth data message to the second host computer to notify the second host computer of the updated security groups. In some embodiments, if no security groups are affected by the migration, the fourth data message is not sent.

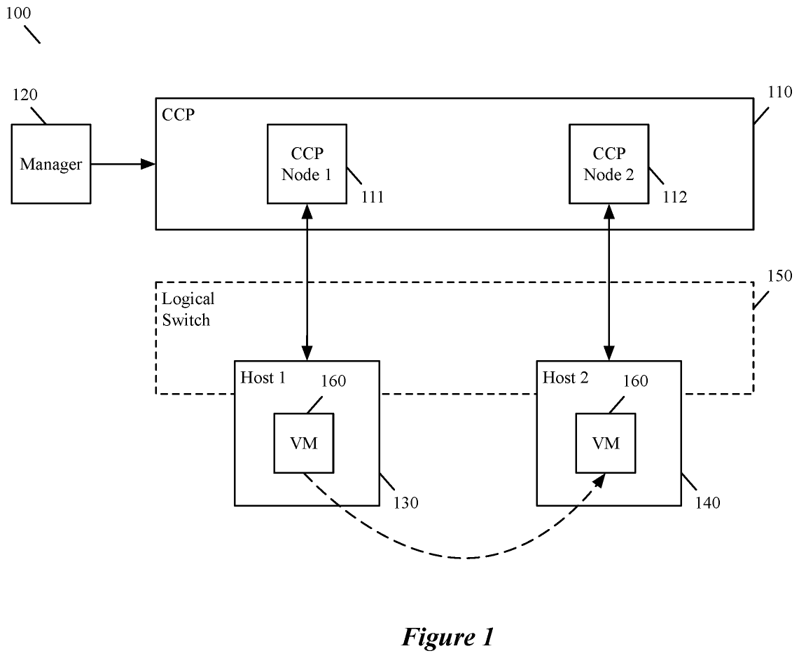

FIG. 1 illustrates an example architecture in which some embodiments are implemented. In a network 100, a CCP 110 interacts with a manager 120 and interacts with hosts (also referred to as host computers) 130 and 140 through a logical switch 150. In some embodiments, the manager 120 receives middlebox service rules from a user or administrator to be applied at the hosts 130 and 140 in the network 100. The manager 120 sends these middlebox service rules to the CCP 110, and the CCP 110 stores these rules and relays the rules to the hosts 130 and 140 through the logical switch 150.

In some embodiments, data compute nodes (e.g., virtual machines, containers, etc.) execute on the hosts 130 and 140. The network 100 may include any number of hosts, and each host may execute any number of VMs or other data compute nodes (DCNs). The middlebox service rules of some embodiments specify security groups of VMs executing on the hosts in the network 100 to which the middlebox service rules are to be applied. Upon receiving a middlebox service rule from the manager 120, the CCP 110 identifies members of one or more security groups associated with the rule, stores the identification of each security group and its members, and sends the identification of the security groups and their members to all hosts along with the middlebox service rules.

In some embodiments, each host in the network 110 is coupled to (i.e., managed by) a CCP node of the CCP 110. A CCP node is a server, which can be machines such as VMs, Pods, containers, standalone host computers, etc. Throughout the Specification, the terms “CCP node” and “CCP server” are used interchangeably. In this example, the first host 130 is coupled to a first CCP node 111 of the CCP 110, and the second host 140 is coupled to a second CCP node 112 of the CCP 110. Data messages sent between the CCP 110 and the hosts 130 and 140 are sent to and from each hosts' corresponding CCP node. Each CCP node 111 and 112 of the CCP 110 includes various components which will be described further below.

Some embodiments of the network 100 provides the ability for VM migration, i.e., migration of a VM from one host to another. In the event of a VM migration, the hosts notify the CCP of the migration via their coupled CCP nodes. In this example, a VM 160 is being migrated from host 130 to host 140, as denoted by a dotted arrow. For this migration process of the VM 160, the CCP 110 receives a VM migration signal first message, a VM removal second message, and a VM addition third message. Further description of these messages will be described below. After receiving and processing these data messages, the CCP 110 determines which security groups have been affected, stores the identification of the updated security groups and their members, and sends a fourth data message to the affected hosts in the network 100 (i.e., the hosts that are part of the VM migration) to notify of the updates to the security groups. While the embodiments described below refer to VM migration, other embodiments perform the same operations for properly processing control plane messages associated with the migration of other types of machines, such as Pods and containers.

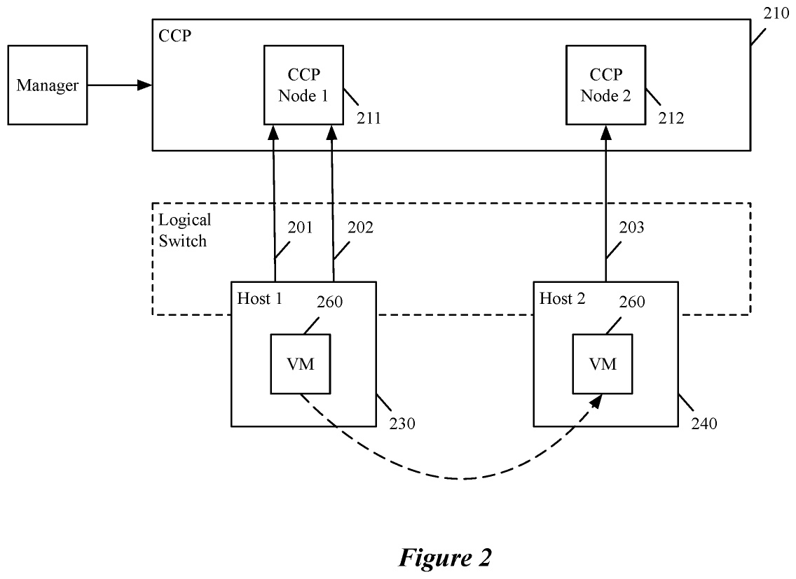

FIG. 2 illustrates a similar example network for VM migration of a VM 260 from a first host 230 to a second host 240. In some embodiments, before the VM migration occurs, the host 230 sends the first CCP node 211 of the CCP 210 a first data message 201 notifying the CCP 210 that the VM 260 will migrate to another host. Receiving this first data message 201 ensures that the CCP 210 (i.e., the first CCP node 211) will not process a VM removal message for the VM 260 before also receiving and processing a VM addition message for the VM 260 (at the second CCP node 212).

The host 230 also sends a second data message 202 to the first CCP node 211 notifying the CCP 210 that the VM 260 has been removed from the host 230. In some embodiments, the second data message 202 is sent to the first CCP node 211 during the migration process. In other embodiments, the second data message 202 is sent to the first CCP node 211 after the migration is complete. The second host 240 sends the second CCP node 212 a third data message 203 notifying the CCP 210 that the VM 260 has been added to the host 240. Like the second data message 202, the third data message 203 may be sent during or after the VM migration process. In some embodiments, a VM migration process occurs between two hosts managed by one CCP node. In such embodiments, the one CCP node receives and processes the first, second, and third data messages.

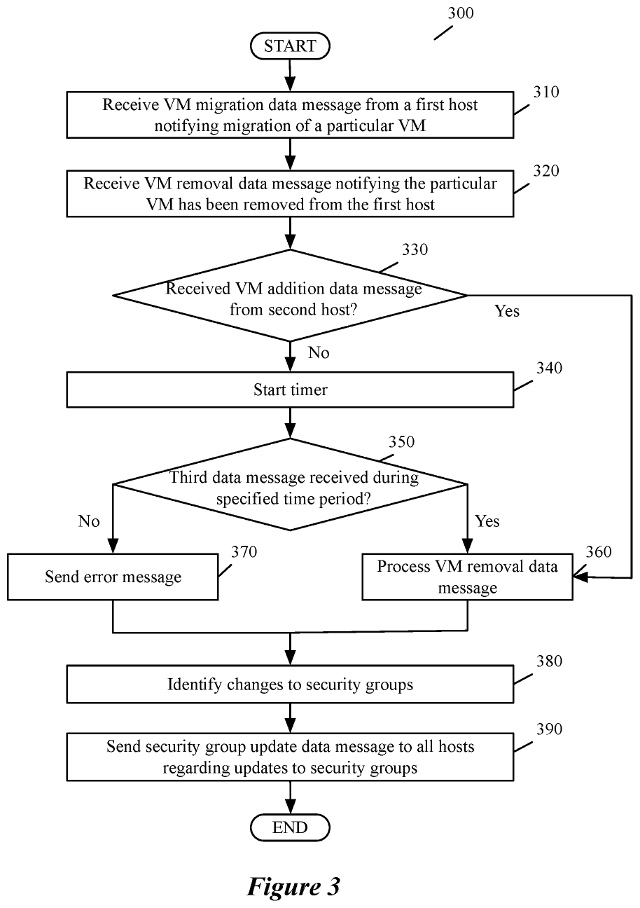

FIG. 3 conceptually illustrates a process 300 of some embodiments for the migration of a particular VM from a first host to a second host. This process 300 may be performed by a particular CCP server of a CCP when a VM migrates from a host computer managed by the particular CCP server to another host computer. In some embodiments, the other host computer is managed by the same CCP server. In other embodiments, the other host computer is managed by another CCP server of the CCP. The following example will be described with reference to the first CCP node 111 of FIG. 1, but it should be understood that the process 300 may be performed by any CCP server of any CCP.

The process 300 begins by receiving (at 310) a VM migration data message from a first host computer notifying migration of a particular VM. In some embodiments, the VM migration data message is received at the particular CCP node before the migration of the particular VM occurs. This data message notifies the particular CCP server of the migration to ensure that the particular CCP server does not process a VM removal data message for the particular VM before a corresponding VM addition data message is processed. In the example of FIG. 1, the first CCP node 111 receives the VM migration data message from the first host 130 notifying the CCP 110 that the migration of the VM 160 will occur.

Next, the process 300 receives (at 320) a VM removal data message from the first host computer notifying that the particular VM has been removed from the first host computer. When the particular VM migrates from the first host computer to the second host computer, the first host computer notifies the particular CCP server that the particular VM is no longer executing on the first host computer in order for the particular CCP server to update the host computer and VM statuses and security groups. Because the particular CCP server has received the VM migration data message notifying the particular CCP server of the VM migration, the particular CCP server understands not to process the VM removal data message before a VM addition data message is received from the second host computer at the CCP server managing the second host computer. In some embodiments, the second host computer is managed by the particular CCP server, and the VM addition data message will be received and processed at the particular CCP server. In other embodiments, the second host computer is managed by another CCP server, and the VM addition data message will be received and processed at the other CCP server. For FIG. 1, the first CCP node 111 receives the VM removal data message from the first host 130 notifying the CCP 110 that the VM 160 has been removed from the first host 130.

Then, the process 300 determines (at 330) whether a VM addition data message has been received from the second host computer notifying that the particular VM has been added to the second host computer. In order to process the VM removal data message, the particular CCP server must determine whether the VM addition data message has been received and processed by the CCP server managing the second host computer. If the VM removal data message is processed before the VM addition data message is received and processed, the particular CCP server may incorrectly update host computer and VM statuses and security groups and may send out incorrect updates to security groups to the first host computer, which would result in incorrectly applied middlebox service rules. In some embodiments, the particular CCP server determines this using a database shared between all CCP servers of the CCP. Further information regarding this shared database will be described below. In other embodiments, if the particular CCP server manages both the first and second host computers, the particular CCP server can determine whether itself has received and processed the VM addition data message. In the example of FIG. 1, the first CCP node 111 determines whether the second CCP node 112 has received the VM addition data message from the second host 140 notifying that the VM 160 has been added to the second host 140. Once the first CCP node 111 receives this VM addition data message, the first CCP node 111 will be able to process the VM removal data message and correctly update the host and VM statuses and the security groups.

If the process 300 determines that the VM addition data message has been received at 330, the process 300 processes (at 360) the VM removal data message. Only after the VM addition data message is received and processed by the CCP server that manages the second host computer (i.e., the particular CCP server or another CCP server), is the particular CCP server able to process the VM removal data message. After processing the VM removal data message, the process 300 identifies (at 380) any changes that need to be made to security groups. For instance, a particular VM's membership for one or more security groups may change when the particular VM migrates from one host computer to another. The particular CCP server identifies those changes to ensure that middlebox service rules are applied to the correct VMs.

After identifying changes or updates to security groups, the process 300 sends (at 390) a security group update data message to the first host computer specifying one or more updates to one or more security groups. After the migration of the particular VM, any security groups affected by the migration must be updated and a notification of these updates is sent to all affected hosts in the network in order for the hosts to correctly apply middlebox service rules associated with the updated security groups. For instance, the update may specify group membership updates, such as IP member updates in the security groups. In embodiments where the particular CCP server receives and processes the VM addition data message (i.e., the particular CCP server manages the second host computer), the particular CCP server also sends this security group update data message to the second host computer. In embodiments where another CCP server receives and processes the VM addition data message (i.e., another CCP server manages the second host computer), the other CCP server sends the security group update data message to the second host computer. In some embodiments, an update is sent to all hosts in the network. Then the process 300 ends.

If the process 300 at 330 determines that the VM addition data message has not been received, the process 300 starts (at 340) a timer to wait a particular time period for the VM addition data message to be received. In some embodiments, the particular time period to wait for the VM addition data message is specified by a user or administrator to wait to receive the VM addition data message before processing the VM removal data message. Next, the process 300 determines (at 350) whether the VM addition data message has been received during the specified time period. If the process 300 determines that the VM addition data message has been received during the particular time period, the process 300 proceeds to steps 360, 380, and 390 as described above and the process 300 ends.

If the process 300 determines that the VM addition data message has not been received during the particular time period, the process 300 in some embodiments starts (at 370) an exception handling process that sends an error message or notification to another program or to an administrator (e.g., by email or text or by creating a record in a log file) to notify of a potential problem with the VM migration. In these embodiments, the process 300 does not process the VM removal data message when it perform the exception handling process. In other embodiments, the timeout triggers the particular CCP server to send the error notification and also to process the VM removal data message without its corresponding VM addition data message being received and processed. Then, the process 300 proceeds to steps 380 and 390 to identify changes to security groups (if affected by a removal of the particular VM in some embodiments) and send the security group update data message to the first host computer notifying of any updates to security groups. The process 300 then ends.

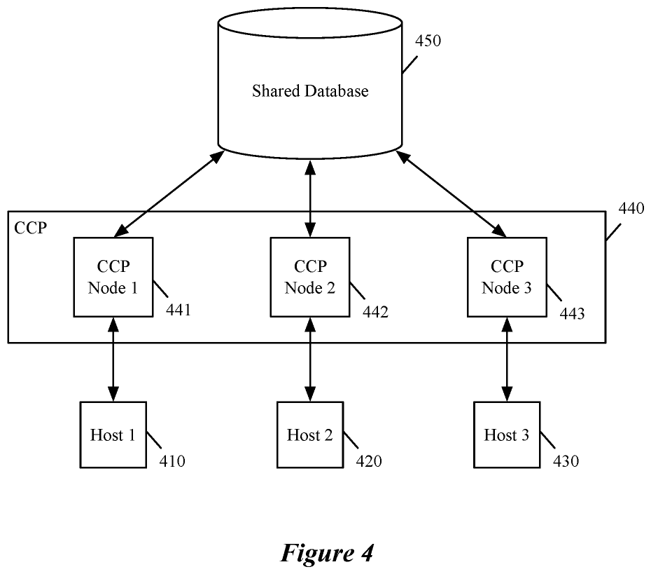

FIG. 4 illustrates an example embodiment of a network that includes hosts 410-430, a CCP 440 with CCP nodes 441-443, and a shared database 450. In some embodiments, each CCP node of a CCP corresponds to only one host. In other embodiments, a CCP node may correspond to two or more hosts. A CCP of some embodiments may include up to three CCP nodes, and each CCP node may manage any number of hosts (e.g., thousands of hosts) in the network. In this example, the CCP 440 includes three CCP nodes 441-443, each corresponding to one of the hosts 410-430. Each of the CCP nodes 441-443 of the CCP 440 use a shared database 450. The shared database 450 may be used for each CCP node 441-443 to store and retrieve (1) middlebox service rules, (2) VM vNIC to logical switch port mappings for all VMs on the hosts 410-430 and ports of a logical switch (not shown) associated with the hosts 410-430, and (3) host and VM statuses for each of the hosts 410-430 and all VMs on the hosts. Each CCP node 441-443 of the CCP 440 in some embodiments includes various components for communicating with hosts and storing and retrieving data from the shared database 450.

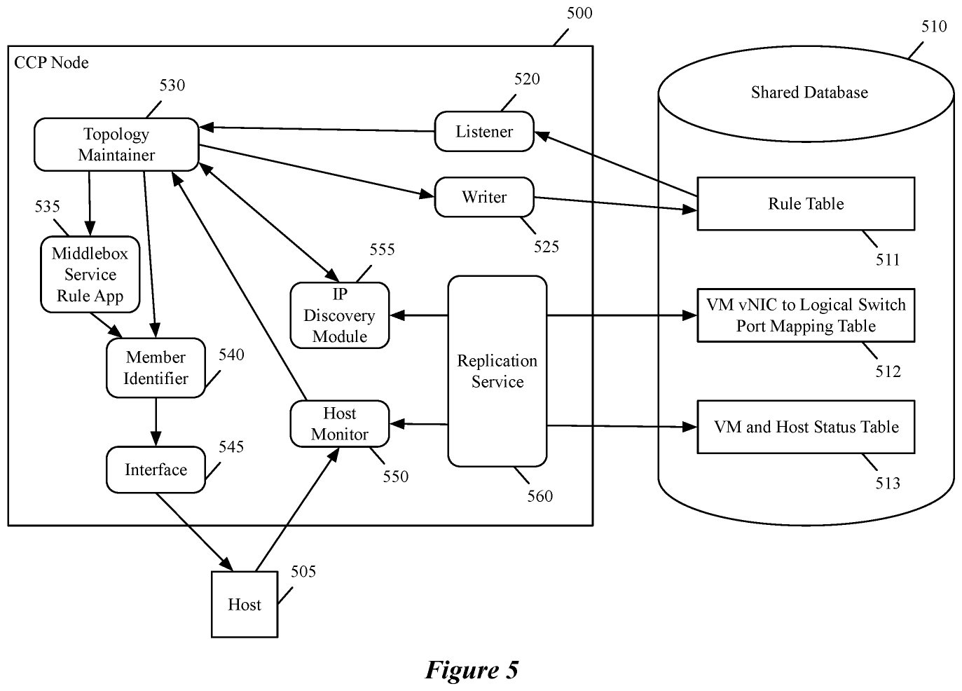

FIG. 5 illustrates an example CCP node 500 and its various components, a shared database 510, and a host 505 coupled to the CCP node 500. All components described for the CCP node 500 may be applied to any CCP node of a CCP, such as CCP nodes 111 and 112 of the CCP 110 of FIG. 1. The shared database 510 stores, for each CCP node of the CCP, a middlebox service rule table 511, a VM vNIC to logical switch port mapping table 512, and a VM and host status table 513. Each CCP node, including the CCP node 500, retrieves and stores this information using the shared database 510. A CCP node can also use this database 510 to determine whether VM removal data messages and VM addition data messages have been received and processed at other CCP nodes. By doing this, a CCP node can properly perform VM migration.

In some embodiments, a manager (such as the manager 120) stores the middlebox service rules in the shared database 510 after receiving the rules from a user. The CCP node 500 retrieves the stored middlebox service rules from the table 511, which is written in a format understood by the user, but not understood by the CCP node 500. The listener 520 converts the middlebox service rules into a local format understood by the CCP node 500 and sends the converted middlebox service rules to the topology maintainer 530. From the perspective of the CCP node 500, the topology maintainer 530 maintains all relationships that the CCP can understand.

When a VM migration occurs on the host 505 (e.g., a VM removal or a VM addition), the host 505 reports this transport node update to the CCP node 500 via the host monitor 550. The host monitor 550 then sends the update to the topology maintainer 530 and persists it to the shared database 510 via the replication service 560. The middlebox service rule application 535 receives this update from the topology maintainer 530 and processes the security group configuration. The member identifier 540 receives updates from the topology maintainer 530 and the middlebox service rule application 535 and identifies members of the security groups. For instance, for a middlebox service rule associated with two security groups, the member identifier 540 identifies each member of the two security groups associated with the middlebox service rule. Then, the member identifier 540 translates the middlebox service rules and their security groups into data messages and sends this information to the host 505 via the interface 545.

In embodiments with multiple CCP nodes for a CCP, the internet protocol (IP) discovery module 555 of the CCP node 500 retrieves VM vNIC to logical switch port mappings from the table 512 and host and VM statuses from the table 513 via the replication service 560, that were stored in the shared database 510 by other CCP nodes. The IP discovery module 555 also receives transport node updates (e.g., VM migration updates) from the topology maintainer 530 for computing updated VM vNIC to logical switch port mappings and host/VM statuses for the migrated VM. Once new mappings and new statuses are computed, the IP discovery module 555 submits the new mappings and host/VM statuses to the topology maintainer 530 to persist it to the tables 512 and 513 in the shared database 510 through the writer 525.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

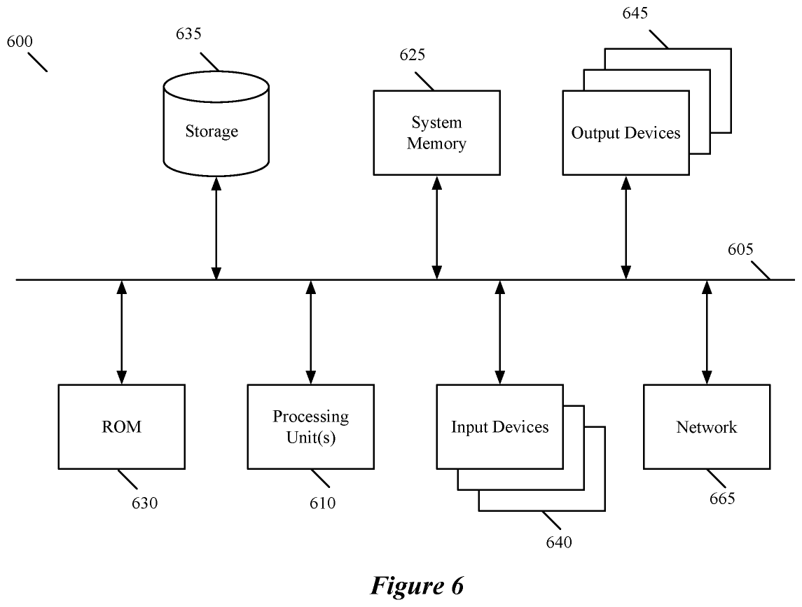

FIG. 6 conceptually illustrates a computer system 600 with which some embodiments of the invention are implemented. The computer system 600 can be used to implement any of the above-described computers and servers. As such, it can be used to execute any of the above described processes. This computer system includes various types of non-transitory machine readable media and interfaces for various other types of machine readable media. Computer system 600 includes a bus 605, processing unit(s) 610, a system memory 625, a read-only memory 630, a permanent storage device 635, input devices 640, and output devices 645.

The bus 605 collectively represents all system, peripheral, and chipset buses that communicatively connect the numerous internal devices of the computer system 600. For instance, the bus 605 communicatively connects the processing unit(s) 610 with the read-only memory 630, the system memory 625, and the permanent storage device 635.

From these various memory units, the processing unit(s) 610 retrieve instructions to execute and data to process in order to execute the processes of the invention. The processing unit(s) may be a single processor or a multi-core processor in different embodiments. The read-only-memory (ROM) 630 stores static data and instructions that are needed by the processing unit(s) 610 and other modules of the computer system. The permanent storage device 635, on the other hand, is a read-and-write memory device. This device is a non-volatile memory unit that stores instructions and data even when the computer system 600 is off. Some embodiments of the invention use a mass-storage device (such as a magnetic or optical disk and its corresponding disk drive) as the permanent storage device 635.

Other embodiments use a removable storage device (such as a flash drive, etc.) as the permanent storage device. Like the permanent storage device 635, the system memory 625 is a read-and-write memory device. However, unlike storage device 635, the system memory is a volatile read-and-write memory, such a random access memory. The system memory stores some of the instructions and data that the processor needs at runtime. In some embodiments, the invention's processes are stored in the system memory 625, the permanent storage device 635, and/or the read-only memory 630. From these various memory units, the processing unit(s) 610 retrieve instructions to execute and data to process in order to execute the processes of some embodiments.

The bus 605 also connects to the input and output devices 640 and 645. The input devices enable the user to communicate information and select commands to the computer system. The input devices 640 include alphanumeric keyboards and pointing devices (also called “cursor control devices”). The output devices 645 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 6, bus 605 also couples computer system 600 to a network 665 through a network adapter (not shown). In this manner, the computer can be a part of a network of computers (such as a local area network (“LAN”), a wide area network (“WAN”), or an Intranet, or a network of networks, such as the Internet. Any or all components of computer system 600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method for processing control plane messages regarding migration of a particular machine from a first host computer managed by a first central control plane (CCP) server to a second host computer, the first CCP server part of a CCP cluster of two or more servers, the method comprising:
at the first CCP server:
receiving a first data message from the first host computer notifying that the particular machine has been removed from the first host computer;
determining whether a second data message from a second host computer notifying that the particular machine has been added to the second host computer has been received and processed by the CCP, in order to process the first data message; and
when it is determined that the second data message has been received and processed, processing the first data message.

2. The method of claim 1 further comprising, when it is determined that the second data message has not been received and processed, waiting a particular period of time in order to process the first data message after the second data message has been received and processed.

3. The method of claim 2, wherein:
when the second data message has been received and processed during the particular period of time, processing the first data message, and
when the second data message has not been received and processed during the particular period of time, sending an error notification to an administrator notifying of a potential problem regarding the migration of the machine.

4. The method of claim 3, wherein the particular period of time is specified by the administrator.

5. The method of claim 1 further comprising receiving a third data message from the first host computer, before receiving the first data message, notifying of the migration of the particular machine from the first host computer to the second host computer.

6. The method of claim 5, wherein the first CCP server receives one or more middlebox service rules to be applied at a plurality of machines, including the particular machine, executing on a plurality of host computers including the first and second host computers.

7. The method of claim 6, wherein the middlebox service rules specify different security groups comprising one or more of the plurality of machines.

8. The method of claim 7 further comprising:
after processing the first data message, sending a fourth data message to the first host computer specifying one or more updates to one or more of the security groups.

9. The method of claim 6, wherein each CCP server configures a different plurality of host computers.

10. The method of claim 9, wherein the second data message is received and processed at the first CCP server.

11. The method of claim 9, wherein the second data message is received and processed at a second CCP sever.

12. The method of claim 9, wherein each CCP server retrieves the middlebox service rules from a shared database.

13. The method of claim 12, wherein each CCP server uses the shared database to store and retrieve (i) the middlebox service rules, (ii) machine virtual network interface card (vNIC) to logical switch port mappings for the plurality of machines and a logical switch associated with the plurality of host computers, and (iii) host computer and machine statuses for the plurality of host computers and the plurality of machines.

14. The method of claim 13, wherein the host computer and machine statuses specify which machines are currently operating on which host computers.

15. The method of claim 14, wherein the first CCP server updates the machine vNIC to logical switch port mappings and the host computer and machine statuses for the particular machine and the first host computer after processing the first data message.

16. A non-transitory machine readable medium storing a program for execution by at least one processing unit for processing control plane messages regarding migration of a particular machine from a first host computer managed by a first central control plane (CCP) server to a second host computer, the program comprising sets of instructions for:
at the first CCP server:
receiving a first data message from the first host computer notifying that the particular machine has been removed from the first host computer;
determining whether a second data message from a second host computer notifying that the particular machine has been added to the second host computer has been received and processed in order to process the first data message; and
when it is determined that the second data message has been received and processed, processing the first data message.

17. The non-transitory machine readable medium of claim 16, wherein:
the program comprises further sets of instructions for, when it is determined that the second data message has not been received and processed, waiting a particular period of time in order to process the first data message after the second data message has been received and processed,
when the second data message has been received and processed during the particular period of time, processing the first data message, and
when the second data message has not been received and processed during the particular period of time, sending an error notification to an administrator notifying of a potential problem regarding the migration of the machine.

18. The non-transitory machine readable medium of claim 16, wherein the program comprises further sets of instructions for receiving a third data message from the first host computer before receiving the first data message notifying of the migration of the particular machine from the first host computer to the second host computer.

19. The non-transitory machine readable medium of claim 18, wherein:
the first CCP server receives one or more middlebox service rules to be applied at a plurality of machines, including the particular machine, executing on a plurality of host computers including the first and second host computers, and
the middlebox service rules specify different security groups comprising one or more of the plurality of machines.

20. The non-transitory machine readable medium of claim 19, wherein the program comprises further sets of instructions for, after processing the first data message, sending a fourth data message to the first host computer specifying one or more updates to one or more of the security groups.
